(19) United States
(12) Patent Application Publication
(10) Pub. No.: US 2021/0033244 A1
(43) Pub. Date: Feb. 4, 2021

(54) MOUNT FOR TREE STAND

(71) Applicant: Fourth Arrow, LLC, Comstock Park, MI (US)

(72) Inventor: Robert M. Wynalda, Jr., Comstock Park, MI (US)

(21) Appl. No.: 16/943,676

(22) Filed: Jul. 30, 2020

Related U.S. Application Data
(60) Provisional application No. 62/880,436, filed on Jul. 30, 2019.

(51) Int. Cl. F16M 13/02; F16M 11/20; G03B 17/56

(52) U.S. Cl. CPC F16M 13/022; F16M 11/2085; F16M 11/2078; A01M 31/02; F16M 2200/021; F16M 2200/068; G03B 17/561

(57) ABSTRACT

An adjustable mount can be secured to a rail of a hunting tree strand. The mount allows a device to be mounted at a comfortable and usable level for one sitting in a tree stand. The mount provides adjustability so that its longitudinal axis can be adjusted to vertical or horizontal even when the rail to which it is mounted is not perfectly horizontal or vertical. The mount can be used for electronic devices such as cameras and range finders. The mount also can be used with run or bow rests.

### CROSS REFERENCE TO RELATED APPLICATIONS

This application claims the benefit of U.S. provisional application No. 62/880,436 filed Jul. 30, 2019; the disclosures of which are incorporated herein by reference.

### BACKGROUND OF THE DISCLOSURE

### 1. Technical Field

The disclosure generally relates to mounts used to hold equipment used during hunting and, more particularly, to a mount used to hold electronics or gun rests from a hunting tree stand or a rail in a hunting blind.

### 2. Background Information

Capturing game hunts on video is difficult in general and particularly difficult for a person hunting alone. Capturing a hunt from a tree stand is particularly problematic given the lack of space and the risk of dropping camera equipment. In most tree stands, there is no room for a camera tripod and specially-designed camera mounts secured to trees are used to securely support a camera while providing control over the camera. Despite the usefulness of these tree-mounted arms, many hunters desire a portable mount that easily carried to and from the field and is also readily mounted to and dismounted from a tree stand structure.

Many tree stands include side and front rails that serve as safety rails for the hunter as well as gun and bow rests. These rails are often formed from tubing with a square cross section. These rails are typically disposed at the level of arm rests and thus position a camera below where a hunter can readily control and reposition the camera during a hunt. For any given tree stand installation, there is little likelihood that any tubing section suitable for mounting a support will be disposed exactly horizontal or exactly vertical thus making it more complicated to mount a camera to one of these structures in a desired level orientation.

### SUMMARY OF THE DISCLOSURE

The disclosure provides an adjustable mount that can be secured to a rail of a hunting tree strand. The mount allows a device to be mounted at a comfortable and usable level for one sitting in a tree stand. The mount also provides adjustability so that the leg of the mount can be moved to a vertical condition. Adjusting the mount leg to vertical places the arm of the mount in a horizontal condition. The mount uses a bowl-style leveling device to provide adjustability in any direction about the longitudinal axis of the leg.

In one configuration, the disclosure provides a device mount that allows the mounted device to be rotated about a first vertical axis at the location where the mounted device is mounted at the end of an arm. The arm itself can rotate about a mount axis which is offset from the first vertical axis by a portion of the length of the arm. The arm can be adjusted to be disposed horizontally when the mount is mounted to a structure that is not, itself, horizontal. The position of the mounted device can be locked during use or provided with frictional resistance so that it can be intentionally moved with some resistance to provide smooth movements.

In one configuration, the mount includes a mounting bracket with an rectangular slot that can be placed over and slid along a rectangular rail of a tree stand. The mounting bracket includes thumb screws that can be tightened to lock the mounting bracket to the rail.

In one configuration, the bowl-style leveling device is secured to the mounting bracket with an interference fit between a raised rail on the mounting bracket and a groove defined by the bottom of the bowl-style leveling device.

The disclosure provides one configuration as a camera mount having a leg disposed above a mounting bracket configured to be secured to a rectangular cross section rail of a tree stand. A bowl-style leveling device is disposed just above the mounting bracket which allows the user to adjust the leg to a vertical position. An arm is rotatably carried at the top of the leg and is disposed horizontal when the leg is vertical. The outer end of the arm has a camera mount thread that allows the user to secure a camera to the end of the arm.

The preceding non-limiting aspects, as well as others, are more particularly described below. A more complete understanding of the apparatus and methods can be obtained by reference to the accompanying drawings, which are not intended to indicate relative size and dimensions of the assemblies or components thereof. In those drawings and the description below, like numeric designations refer to components of like function. Specific terms used in that description are intended to refer only to the particular structure of the embodiments selected for illustration in the drawings, and are not intended to define or limit the scope of the disclosure.

### BRIEF DESCRIPTION OF THE DRAWINGS

FIG. 1 is a perspective view of an exemplary configuration of the mount.

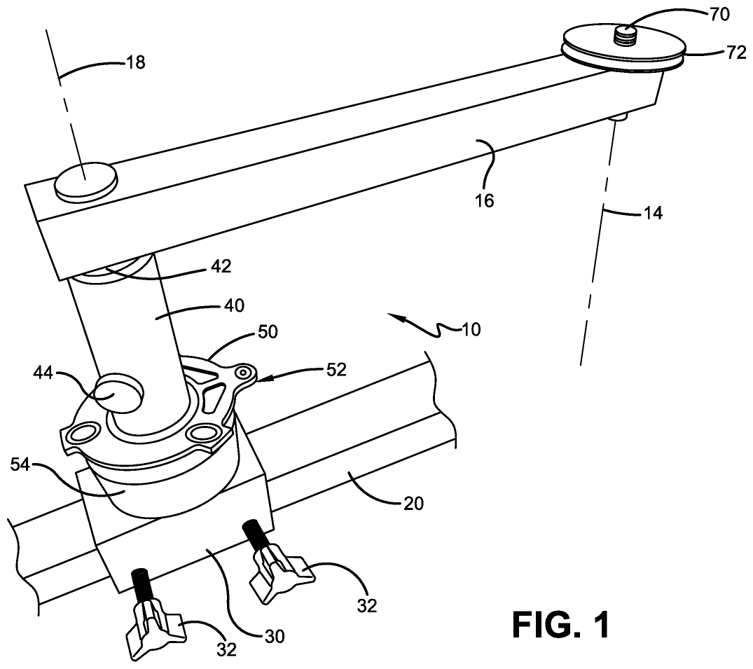

FIG. 2 is another perspective view of the mount of FIG. 1.

FIG. 3 is an end view of the mount of FIG. 1.

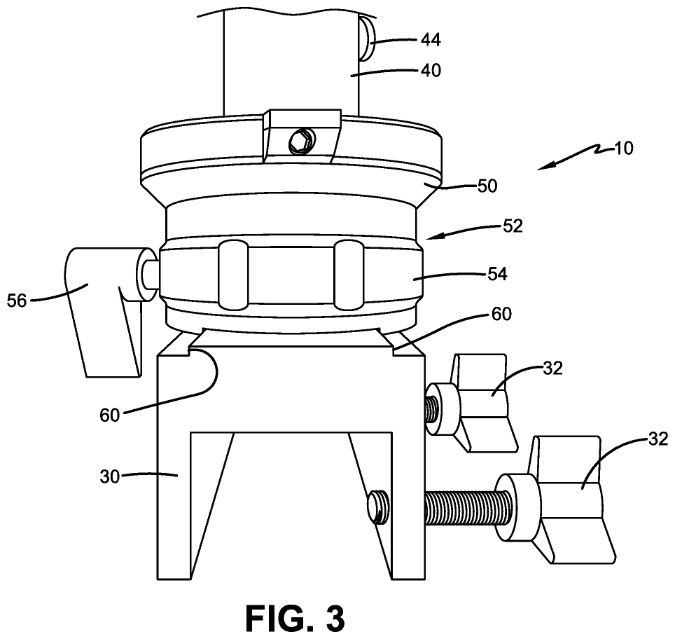

### DETAILED DESCRIPTION OF THE DISCLOSURE

An exemplary configuration of a tree stand mount is indicated generally by the reference numeral 10 in the accompanying drawings. Mount 10 can be used to mount a device 12 such as an electronic device such as a camera or a range finder in a position convenient for a person sitting in a tree stand. Mount 10 also can be used to support a device 12 such as gun or bow rest. Mount 10 is configured to be mounted to a rail on a tree stand. Mount 10 allows the orientation of the mount's longitudinal axis 18 to be adjusted in any direction about that axis after mount 10 is secured to the rail. As such, axis 18 can be adjusted to vertical. Device 12 can be mounted directly on top of mount 10 or an arm 16 can be used to offset the mounted position of device 12 and to allow device 12 to be moved about mount 10 along an arc.

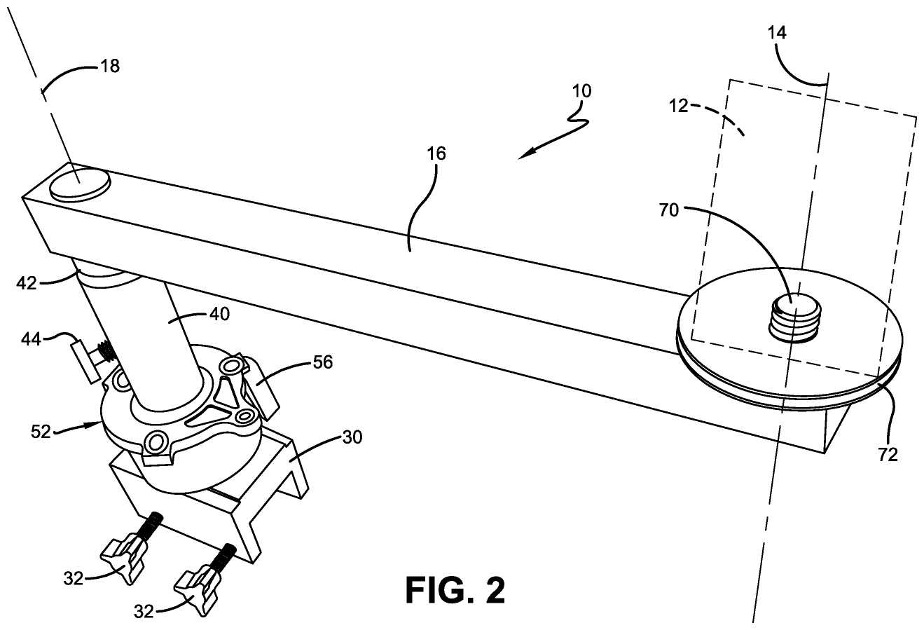

In the exemplary configuration, an arm 16 is connected to mount 10 to form an assembly. In an unlocked condition, arm 16 can rotate 360 degrees about mount's longitudinal axis 18. The outer end of arm 16 includes a device mount that selectively allows mounted device 12 (FIG. 2) to be rotated 360 degrees about a device mount axis 14 that is substantially parallel to axis 18. The position of the mounted device 12 can be locked in place by tightening the device mount to a locked condition.

Arm 16 can rotate about axis 18 at the inner end of arm 16 which is offset from first vertical axis 14 by most of the length of arm 16. Second vertical axis 18 is disposed at the location where mount 10 is secured. Arm 16 can rotate 360 degrees and be selectively locked in place with a thumb screw 44. Mount 10 is adjustable to allow the user to make adjustments so that axes 14 and 18 are vertical with arm 16 horizontal when mount 10 is secured to a generally horizontal structure such as a rail of a tree stand or a rail in a hunting blind.

Mount 10 is configured to be mounted to a rail 20 of a tree stand or other device wherein the rail has a rectangular cross section. For example, rail 20 can be located in a hunting blind. Many existing and new tree stands use rails with rectangular cross sections for arm rests, safety bars, and gun rests. Mount 10 can be secured to these rails to position device 12 in a convenient location for the user disposed behind the rail. Mount 10 includes a three-sided, mounting bracket 30 defining a rectangular opening that receives rail 20. Mounting bracket 30 can thus be fit over a section of rail 20 and slide back and forth to a desired location. First and second threaded thumb screws 32 are used to secure the location of mounting bracket 30 to rail 20. Mounting bracket 30 can sit on top of rail 20 so that axis 18 is generally vertical or mounting bracket 30 can slide onto the side or front of rail 20 so that axis 18 is generally horizontal.

In the exemplary configuration, arm 16 is carried at the top of a leg 40 that defines an opening which receives an arm mounting pin 42 that extends down from the inner end of arm 16. Leg 40 is straight with a threaded mounting opening at its lower end. Mounting pin 42 is selectively rotatably received inside the top of leg 40. In one configuration, mounting pin 42 is sized to frictionally fit within leg 40 and the relative sizes provide a tight fit that allows rotation. In another configuration, bushings or bearings are used between the two elements to provide smooth movement. A thumb screw 44 is used to selectively lock the position of mounting pin 42 with respect to leg 40. When arm 16 does not rotate with respect to pin 42, thumb screw 44 also locks the position of arm 16 with respect to leg 40. Leg 40 is used to raise device 12 to a convenient location with respect to the user's head especially when mount 10 is secured to an arm rest rail 20. When device 12 is a camera, this position allows the user to frame the scene of a hunt and operate the controls of a camera with minimal movement. Different length legs 40 can be provided.

The bottom end of leg 40 is carried by an adjustable portion 50 of a bowl-style leveling device 52 which has a base 54 that is secured to mounting bracket 30. Bowl-style leveling device 52 allows leg 40 and thus longitudinal axis 18 to be adjusted in any direction with respect to axis 18 within the limits of device 52 (such as 10-20 percent). An exemplary leveling device is an LB-60 leveling device. This allows the user to adjust leg 40 to a vertical condition (with axis 18 vertical) when rail 20 is not disposed horizontally but is within the range of adjustment to horizontal. A lock 56 is used to selectively lock the position of adjustable portion 50 and leg 40 with respect to mounting bracket 30.

The top of mounting bracket 30 is provided with a raised rail 60 that can be dovetailed to receive base 54 of leveling device 52. Base 54 defines a groove that receives rail 60. A threaded connector can be used though mounting bracket 30 into base 54.

The outer end of the arm 16 has a camera mount thread 70 that allows the user to secure a camera to the outer end of the arm 16. Thread 70 can be rotated and then locked into place. The lock can be a thumb screw that tightens the base 72 of mount thread down against arm 16. Other device mounts can be disposed at the outer end of arm 16 such as mounts that clamp onto the sides of a smart phone. A gun or bow rest also can be carried by the outer end of arm 16.

The arm 16 can be adjusted to be disposed horizontally when mounted to a structure that is not, itself, horizontal. The position of the mounted device can be locked during use or provided with frictional resistance so that it can be intentionally moved with some resistance to provide smooth movements. The user secures mounting bracket 30 to a location that places the outer end of arm 16 in a convenient location. The user then secures thumb screws 32 to lock the position of mounting bracket 30 with respect to rail 20. The user then adjusts the position of leg 40 until it is substantially vertical which levels arm 16 to a horizontal position. The user can then mount a camera or other device to arm 16 and position it as desired.

Mount 10 also allows arm 16 to be disposed vertical when bracket 30 is secured to the front or side of rail 20 or is secured to a rail 20 that is disposed substantially vertical. In this configuration, axis 14 is disposed horizontal and the user can rotate arm 16 within a vertical reference plane to move device 12. This is useful for some smart phone mounts that grip the sides of the phone.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Modifications and alterations of those embodiments will be apparent to one who reads and understands this general description. The present disclosure should be construed as including all such modifications and alterations insofar as they come within the scope of the appended claims or equivalents thereof. Throughout the description and claims of this specification the words “comprise” and “include” as well as variations of those words, such as “comprises,” “includes,” “comprising,” and “including” are not intended to exclude additives, components, integers, or steps.

1. A device mount for a rectangular tree stand rail, the mount comprising:
a mounting bracket having an opening with a rectangular cross section; the mounting bracket adapted to fit over a portion of the rectangular tree stand rail; the mounting bracket including a first thumb screw movable with respect to the mounting bracket to secure the mounting bracket onto the tree stand rail;
a bowl-style leveling device disposed above and carried by the mounting bracket; the bowl-style leveling device having locked and unlocked conditions;
a leg disposed above and carried by the bowl-style leveling device; the leg having a longitudinal axis; the unlocked condition of the bowl-style leveling device allowing the orientation of the leg to be adjusted with respect to the mounting bracket;
an arm selectively rotatably carried by the leg and disposed horizontal when the leg is disposed vertical; and
the arm having a camera mount thread adapted to allow a camera to be secured to the end of the arm.

2. The device of claim 1, wherein the arm has an inner end rotatable connected to the leg and an outer end; the camera mount disposed at the outer end of the arm.

3. The device of claim 1, wherein the mounting bracket defines a raised rail disposed in a groove defined by the leveling device.

4. The device of claim 1, further comprising a locking device that locks the position of the arm with respect to the leg.

5. The device of claim 1, wherein the mounting bracket includes a second thumb screw movable with respect to the mounting bracket to secure the mounting bracket onto the tree stand rail; the second thumb screw being spaced from the first thumb screw.

6. A device mount for a rectangular rail, the mount comprising:
a mounting bracket adapted to fit over a portion of the rectangular tree stand rail; the mounting bracket including a first thumb screw movable with respect to the mounting bracket to secure the mounting bracket onto the rail;
a bowl-style leveling device disposed above and carried by the mounting bracket; the bowl-style leveling device having locked and unlocked conditions; and
a leg disposed above and carried by the bowl-style leveling device; the leg having a longitudinal axis; the unlocked condition of the bowl-style leveling device allowing the orientation of the leg to be adjusted with respect to the mounting bracket.

7. The device of claim 6, further comprising an arm selectively rotatably carried by the leg and disposed horizontal when the leg is disposed vertical.

8. The device of claim 7, wherein the arm has a camera mount thread adapted to allow a camera to be secured to the end of the arm.

9. The device of claim 8, wherein the arm has an inner end rotatable connected to the leg and an outer end; the camera mount disposed at the outer end of the arm.

10. The device of claim 7, further comprising a locking device that locks the position of the arm with respect to the leg.

11. The device of claim 6, wherein the mounting bracket defines a raised rail disposed in a groove defined by the leveling device.

12. The device of claim 6, wherein the mounting bracket includes a second thumb screw movable with respect to the mounting bracket to secure the mounting bracket onto the tree stand rail; the second thumb screw being spaced from the first thumb screw.

13. A tree stand comprising:
a rectangular tree stand rail;
a mounting bracket having an opening with a rectangular cross section; the mounting bracket disposed over a portion of the rectangular tree stand rail;
the mounting bracket including a first thumb screw engaging the rectangular tree stand rail to secure the mounting bracket onto the tree stand rail;
a bowl-style leveling device having an adjustable portion selectively and adjustably carried by a base; the base of the bowl-style leveling device being carried by the mounting bracket; the bowl-style leveling device having locked and unlocked conditions;
a leg carried by the adjustable portion of the bowl-style leveling device; the leg having a longitudinal axis; the unlocked condition of the bowl-style leveling device allowing the orientation of the leg to be adjusted with respect to the mounting bracket;
an arm selectively rotatably carried by the leg and disposed horizontal when the leg is disposed vertical; and
the arm having a camera mount thread adapted to allow a camera to be secured to the end of the arm.

14. The device of claim 13, wherein the arm has an inner end rotatable connected to the leg and an outer end; the camera mount disposed at the outer end of the arm.

15. The device of claim 13, wherein the mounting bracket defines a raised rail disposed in a groove defined by the base of the leveling device.

16. The device of claim 13, further comprising a locking device that locks the position of the arm with respect to the leg.

17. The device of claim 13, wherein the mounting bracket includes a second thumb screw movable with respect to the mounting bracket to secure the mounting bracket onto the tree stand rail; the second thumb screw being spaced from the first thumb screw.
